(19) United States
(12) Patent Application Publication
(10) Pub. No.: US 2022/0391909 A1
(43) Pub. Date: Dec. 8, 2022

(54) NOT PRESENT DISTRIBUTION COMMUNICATIONS TEIRED AUTHENTICATOR SYSTEM

(71) Applicant: BANK OF AMERICA CORPORATION, Charlotte, NC (US)

(72) Inventor: Hosam Sonny ElHamahmy, Fort Mill, SC (US)

(73) Assignee: BANK OF AMERICA CORPORATION, Charlotte, NC (US)

(21) Appl. No.: 17/336,418

(22) Filed: Jun. 2, 2021

(51) Int. Cl. G06Q 20/40; G06Q 20/38; G06Q 20/06

(52) U.S. Cl. CPC G06Q 20/4016; G06Q 20/4014; G06Q 20/3821; G06Q 20/389; G06Q 20/06

(57) ABSTRACT

Embodiments of the invention are directed to a system, method, or computer program product for a vehicle not present distribution communications tiered authenticator. This invention creates an instant authentication notification process to notify a user when a resource distribution is occurring in a vehicle not present resource distribution event. A user threshold matrix is generated a pre-determined threshold for threshold datapoints associated with a vehicle not present resource distribution event. The invention identifies a vehicle not present resource distribution event and confirms if the even triggers the user threshold matrix. If so, an authentication communication is transmitted to the user for real-time vehicle not present resource distribution approval prior to allowance of rail processing.

### BACKGROUND

Currently, typical vehicle not present distributions, such as those over the phone or the like are not as secure as present distributions and can be misappropriated. As such, a need exists for a vehicle not present distribution communication authenticator system.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

In some embodiments, the invention creates an instant notification process to notify a user when a transaction is occurring in a vehicle not present distribution. Furthermore, these notifications may be user controlled. In this way, the user may determine for what types of transactions, what merchant, a dollar amount, frequency, or the like as to when the notification is presented to the user. If the card vehicle not present distribution reaches the triggering threshold, a notification is provided to the user and must be accepted prior to allowing the transaction to be processed.

Typically card vehicle not present transactions, such as those over a phone or the like are relatively rare. However, card vehicle not present transactions are not always as secure as possible and can be easily misappropriated. If a credit card number is given over the phone or via the internet, there is no real way of verifying that it is the user giving that number or an imposter. This invention creates a secure notification and communications network with tiered authentication for approving these vehicle not present resource distributions.

Embodiments of the present invention address these and/or other needs by providing an innovative system, method and computer program product for vehicle not present resource distribution communications tiered authentication, the invention comprising: creating linkage with a user device associated with a user, wherein the linkage is based on user authorization and links user resource distribution accounts for vehicle not present distribution communications identification; pre-populating a user threshold matrix for vehicle not present resource distribution communications based on user selection of threshold matrix options; identifying a vehicle not present resource distribution communication with the user as a party to the communication; comparing details of the vehicle not present resource distribution communication not the user threshold matrix; triggering, based on one or more thresholds being met from the threshold matrix options of the user, an authorization notification to a user device associated with the user; and requiring a positive response from the user device to not block the vehicle not present resource distribution communication from processing.

In some embodiments, the user threshold matrix comprises threshold amounts for vehicle not present distribution communications related to the threshold matrix options comprising resource distribution types, merchant types, time of communications, resource distribution amount, frequency of communications, and location of the user and merchant during the vehicle not present distribution communications. In some embodiments, the user threshold matrix comprises selection of one or more of the threshold matrix options.

In some embodiments, triggering the authorization notification to the user device associated with the user further comprises intercepting resource distribution processing at a payment rail for the vehicle not present resource distribution until confirmed authorization notification response.

In some embodiments, identifying the vehicle not present resource distribution communication with the user as a party to the communication further comprises monitor a payment rail for vehicle not present resource distributions associated with the user account.

In some embodiments, identifying the vehicle not present resource distribution communication with the user as a party to the communication further comprises receiving communication of the vehicle not present resource distribution communication from the user, a merchant, or a user account.

In some embodiments, requiring the positive response from the user device to not block the vehicle not present resource distribution communication from processing further comprises blocking the vehicle not present resource distribution communication upon no response being received from the user device, wherein blocking the vehicle not present resource distribution communication prevents a transaction from occurring.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a s vehicle not present distribution communication tiered authenticator system environment, in accordance with one embodiment of the present invention;

FIG. 2 provides a process for implementing the tiered authentication system for vehicle not present resource distribution communications, in accordance with one embodiment of the present invention;

FIG. 3 provides a system interaction process for implementation the tiered authentication system for vehicle not present resource distribution communications, in accordance with one embodiment of the present invention; and

FIG. 4 provides a process flow illustrating setting up the user threshold matrix for the tiered authentication system, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

A “user” as used herein may refer to individual performing a vehicle not present resource distribution. The user may interact with a merchant, such as a customer purchasing a product or service from a merchant online, over the phone, or via any other vehicle not present distribution means. Furthermore, as used herein the term “user device” or “mobile device” may refer to mobile phones, personal computing devices, tablet computers, wearable devices, and/or any portable electronic device capable of receiving and/or storing data therein.

As used herein, a “user interface” generally includes a plurality of interface devices and/or software that allow a customer to input commands and data to direct the processing device to execute instructions. For example, the user interface may include a graphical user interface (GUI) or an interface to input computer-executable instructions that direct the processing device to carry out specific functions. Input and output devices may include a display, mouse, keyboard, button, touchpad, touch screen, microphone, speaker, LED, light, joystick, switch, buzzer, bell, and/or other user input/output device for communicating with one or more users.

A “technology activity” may include a transaction for a product or service from a merchant. A “transaction” or “resource distribution” refers to any communication between a user and a merchant to transfer funds for the purchasing or selling of a product or service. A transaction may refer to a purchase of goods or services, a return of goods or services, a payment transaction, a credit transaction, or other interaction involving an account. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

Further, the term “payment credential” or “payment vehicle,” as used herein, may refer to any of, but is not limited to refers to any of, but is not limited to, a physical, electronic (e.g., digital), or virtual transaction vehicle that can be used to transfer money, make a payment (for a service or good), withdraw money, redeem or use loyalty points, use or redeem coupons, gain access to physical or virtual resources, and similar or related transactions. For example, in some embodiments, the payment vehicle is a bank card issued by a bank which a customer may use to perform purchase transactions. However, in other embodiments, the payment vehicle is a virtual debit card housed in a mobile device of the customer, which can be used to electronically interact with an ATM or the like to perform financial transactions. Thus, it will be understood that the payment vehicle can be embodied as an apparatus (e.g., a physical card, a mobile device, or the like), or as a virtual transaction mechanism (e.g., a digital transaction device, digital wallet, a virtual display of a transaction device, or the like). The payment vehicle may be an unrestricted resource. Unrestricted resources, as used herein may be any resource that is not restricted for transaction. In this way, the unrestricted resources may be applied to any transaction for purchase of a product or service.

In some embodiments, the invention creates an instant notification process to notify a user when a transaction is occurring in a vehicle not present distribution. Furthermore, these notifications may be user controlled. In this way, the user may determine for what types of transactions, what merchant, a dollar amount, frequency, or the like as to when the notification is presented to the user. If the card vehicle not present distribution reaches the triggering threshold, a notification is provided to the user and must be accepted prior to allowing the transaction to be processed.

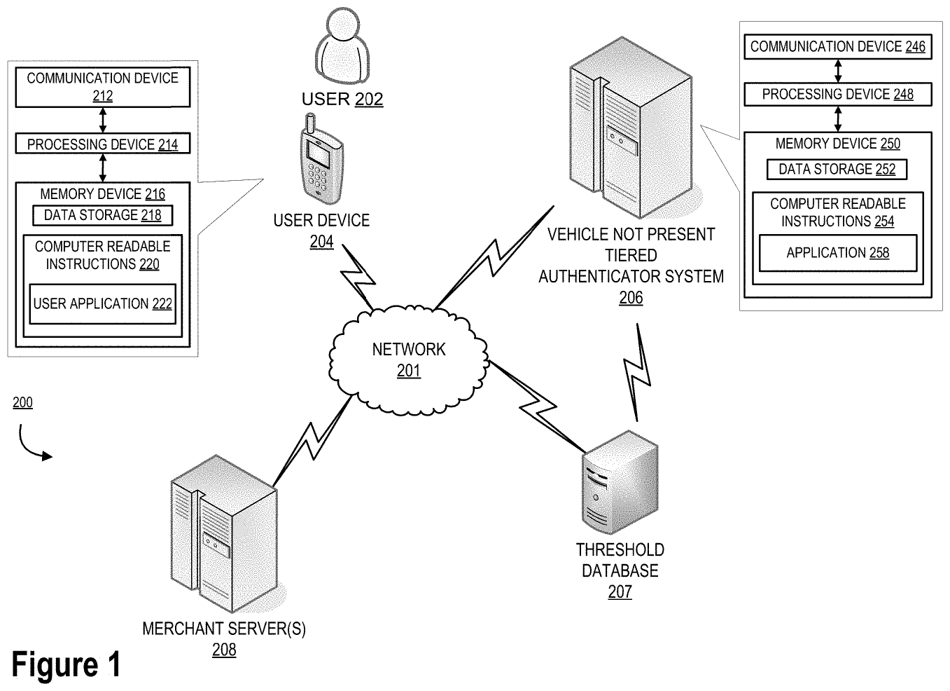

FIG. 1 provides a vehicle not present distribution communication tiered authenticator system environment 200, in accordance with one embodiment of the present invention. FIG. 1 provides the system environment 200 for which the distributive network system with specialized data feeds. FIG. 1 provides a unique system that includes specialized servers and system communicably linked across a distributive network of nodes required to perform the functions described herein.

As illustrated in FIG. 1, the merchant server 208 is operatively coupled, via a network 201 to the user device 204, threshold database 207, and to the vehicle not present tiered authenticator system 206. In this way, the merchant server 208 can send information to and receive information from the user device 204, threshold database 207, and the vehicle not present tiered authenticator system 206. FIG. 1 illustrates only one example of an embodiment of the system environment 200, and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 is an individual or entity performing or initiating performance of a vehicle not present resource distribution. In this way, the user 202 is providing a payment vehicle to a merchant when the user 202 and the merchant are not physically together, as such the resource distribution is a user vehicle not present distribution. In some embodiments, the user 202 has a user device 204, such as a mobile phone, tablet, computer, or the like. FIG. 1 also illustrates a user device 204. The user device 204 may be, for example, a desktop personal computer, business computer, business system, business server, business network, a mobile system, such as a cellular phone, smart phone, personal data assistant (PDA), laptop, or the like. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the vehicle not present tiered authenticator system 206, the merchant server 208, and the third party sever 207. As such, the communication device 212 generally comprises a modem, server, or other device for communicating with other devices on the network 201.

The user device 204 comprises computer-readable instructions 220 and data storage 218 stored in the memory device 216, which in one embodiment includes the computer-readable instructions 220 of a user application 222. In some embodiments, the user application 222 allows a user 202 to send and receive communications with the vehicle not present tiered authenticator system 206.

As further illustrated in FIG. 1, the vehicle not present tiered authenticator system 206 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the merchant server 208, the threshold database 207, the point-of-transaction device 205, and the user device 204. As such, the communication device 246 generally comprises a modem, server, or other device for communicating with other devices on the network 201.

As further illustrated in FIG. 1, the vehicle not present tiered authenticator system 206 comprises computer-readable instructions 254 stored in the memory device 250, which in one embodiment includes the computer-readable instructions 254 of an application 258. In some embodiments, the memory device 250 includes data storage 252 for storing data related to the system environment 200, but not limited to data created and/or used by the application 258.

In one embodiment of the vehicle not present tiered authenticator system 206 the memory device 250 stores an application 258. In one embodiment of the invention, the application 258 may associate with applications having computer-executable program code. Furthermore, the vehicle not present tiered authenticator system 206, using the processing device 248 codes certain communication functions described herein. In one embodiment, the computer-executable program code of an application associated with the application 258 may also instruct the processing device 248 to perform certain logic, data processing, and data storing functions of the application. The processing device 248 is configured to use the communication device 246 to communicate with and ascertain data from one or more merchant server 208, threshold database 207, and/or user device 204.

In the embodiment illustrated in FIG. 1, an application allows the vehicle not present tiered authenticator system 206 to be linked to the threshold database 207 and other devices on the network to communicate, via a network 201, the information related to the vehicle not present transaction being made, such as the transaction type, cost of transaction, product type, merchant location, and the like. In this way, the threshold database 207 may provide confirmation authorization of a potential transaction that meets a user pre-defined threshold for authentication of a vehicle not present transaction

In some embodiment, the merchant module may provide confirmation of authorization of a potential communication between the user 202 and merchant. In this way, the user 202 may interact with the vehicle not present tiered authenticator system 206 to ensure that the user is authorized for the vehicle not present resource distribution. This interaction provides security functions, as well as initiating a transaction communication between the user device and the devices on the system 200, such as the merchant server 208.

As illustrated in FIG. 1, the threshold database 207 is connected to the merchant server 208, user device 204, and vehicle not present tiered authenticator system 206. The threshold database 207 has the same or similar components as described above with respect to the user device 204 and the vehicle not present tiered authenticator system 206. While only one threshold database 207 is illustrated in FIG. 1, it is understood that multiple threshold database 207 may make up the system environment 200. The threshold database 207 may be associated with one or more financial institutions, entities, or the like.

The threshold database 207 is in direct communication with the vehicle not present tiered authenticator system 206 and is in communication with the other devices via the network 201. The threshold database 207 stores user 202 threshold information. This threshold information may include one or more amounts, merchants, payment vehicles, or the like that would trigger a notification of a vehicle not present transaction being processed for a user 202 using a user account.

As illustrated in FIG. 1, the merchant server 208 is connected to the threshold database 207, user device 204, and vehicle not present tiered authenticator system 206. The merchant server 208 may be associated with the vehicle not present tiered authenticator system 206. The merchant server 208 has the same or similar components as described above with respect to the user device 204 and the vehicle not present tiered authenticator system 206. While only one merchant server 208 is illustrated in FIG. 1, it is understood that multiple merchant server 208 may make up the system environment 200. It is understood that the servers, systems, and devices described herein illustrate one embodiment of the invention. It is further understood that one or more of the servers, systems, and devices can be combined in other embodiments and still function in the same or similar way as the embodiments described herein. The merchant server 208 may generally include a processing device communicably coupled to devices as a memory device, output devices, input devices, a network interface, a power source, one or more chips, and the like. The merchant server 208 may also include a memory device operatively coupled to the processing device. As used herein, memory may include any computer readable medium configured to store data, code, or other information. The memory device may include volatile memory, such as volatile Random Access Memory (RAM) including a cache area for the temporary storage of data. The memory device may also include non-volatile memory, which can be embedded and/or may be removable. The non-volatile memory may additionally or alternatively include an electrically erasable programmable read-only memory (EEPROM), flash memory or the like.

The memory device may store any of a number of applications or programs which comprise computer-executable instructions/code executed by the processing device to implement the functions of the merchant server 208 described herein.

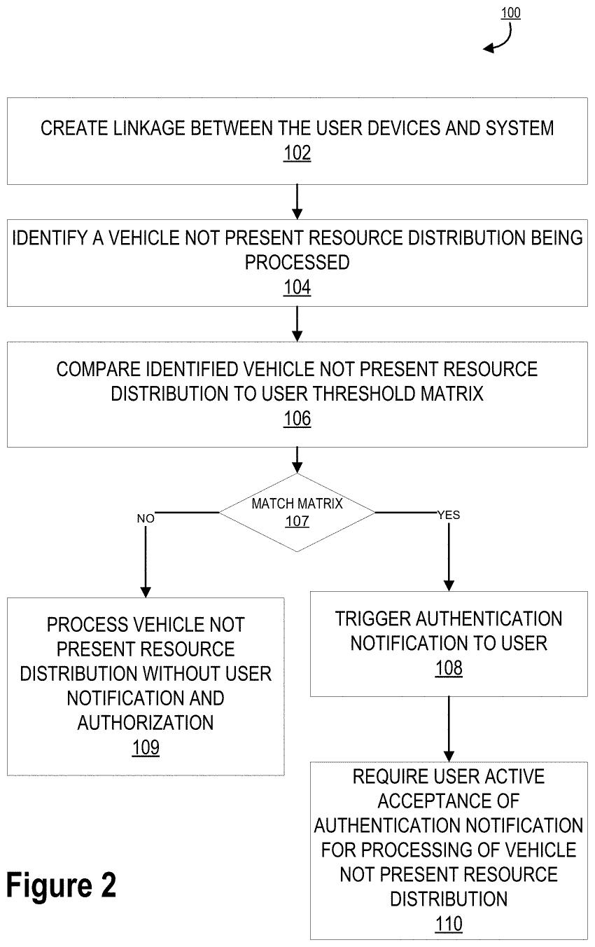

FIG. 2 provides a process for a process for implementing the tiered authentication system for vehicle not present resource distribution communications 100, in accordance with one embodiment of the present invention. As illustrated in block 102, the process 100 is initiated by creating a linkage between the user device and the system. In this way, the system may be able to be in communication with the user device over a network. The linkage may be authorized by the user such that the user approves the implementation of the tiered authentication system.

Once the linkage has been approved, the system may be able to monitor for and identify when a card vehicle not present resource distribution is being processed, as illustrated in block 104. In this way, the system may monitor user account activity, user device activity, merchant device activity, or the like to identify when a card vehicle not present resource distribution is being initiated. In some embodiments, the system recognized the transaction being a vehicle not present resource distribution based on the terminal type being used for completion of the transaction. In some embodiments, the system may identify card vehicle not present transactions based on user account communications and changes to the resource amount and potential resource distribution from the user accounts in real-time. In some embodiments, the system may identify card vehicle not present transactions based on user device access of websites or voice communications from the user to a merchant. In some embodiments, the system may monitor a payment rail for vehicle not present transactions associated with the user to identify vehicle not present transactions associated with a user account. In this way, the system is able to intercept a payment processing at the payment rail for a vehicle not present resource distribution until the system receives approval from the user.

As illustrated in block 104, the system is able to identify a card vehicle not present resource distribution being processed via a payment rail. A vehicle not present resource distribution may be any over the phone, over the Internet, or other means of processing a resource distribution without the user being physically present at the merchant point of transaction.

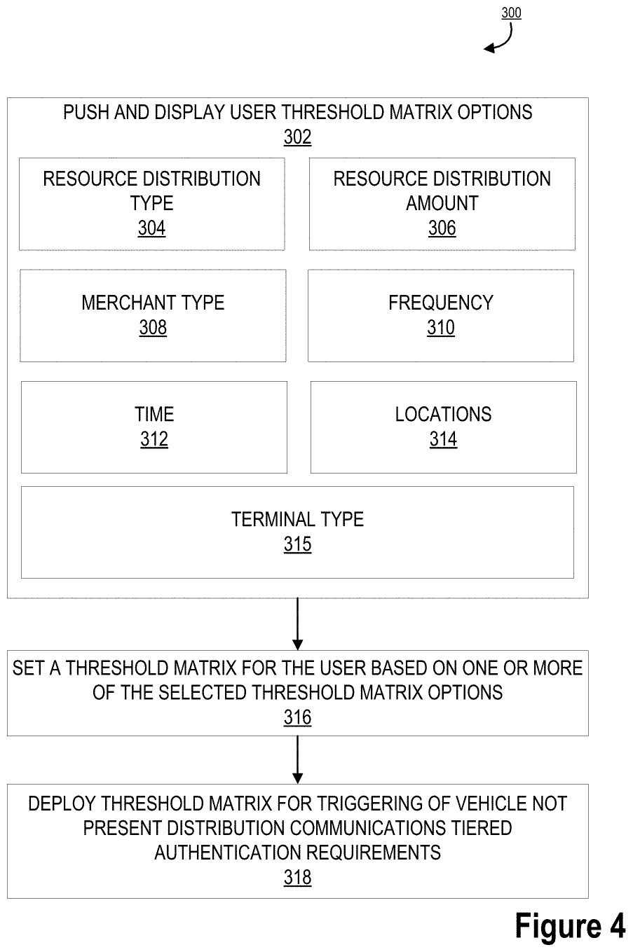

Once, the vehicle not present resource distribution is identified, the system continues by comparing the identified vehicle not present resource distribution associated with the user and user account, to a pre-existing user threshold matrix, as illustrated in block 106. The user threshold matrix is further illustrated below with respect to FIG. 4. The user threshold matrix allows for a user to determine a threshold amount, time frame, merchant, merchant category, or the like that requires system triggering and transmission of an authentication request to a user. However, if the vehicle not present resource distribution does not escalate to the threshold, the system allows the resource distribution to be processed without user authentication.

As illustrated in block 107, the system compares the details of the vehicle not present resource distribution request identified as being associated with one or more of the user accounts to the user threshold matrix to determine of one or more of the user pre-defined thresholds have been satisfied. These may include an amount of resources, specific locations, specific merchants, times of day, or the like. As illustrated in block 109, if a threshold of the user threshold matrix for the vehicle not present transaction is not met, then the system allows for processing of the vehicle not present resource distribution without user notification and authorization. In this way, the system is not triggered to require additional user authorization and allows for the payment processing to continue without interruption.

Referring back to block 107, if the system compares the details of the vehicle not present resource distribution request identified as being associated with one or more of the user accounts to the user threshold matrix and determines that one or more of the user pre-defined thresholds have been satisfied, the system triggers the user authentication and notification. As illustrated in block 108, upon identification of a threshold matrix being met by the vehicle not present transaction, the system triggers the authentication notification to the user.

Finally, as illustrated in block 110, the process 100 is completed by requiring the user to actively accept the authentication notification for processing of the vehicle not present resource distribution. In this way, the system transmits a notification requiring user approval to a user device. Upon positive active acceptance of the authentication notification, the system allows for the vehicle not present transaction to be processed via an appropriate payment rail.

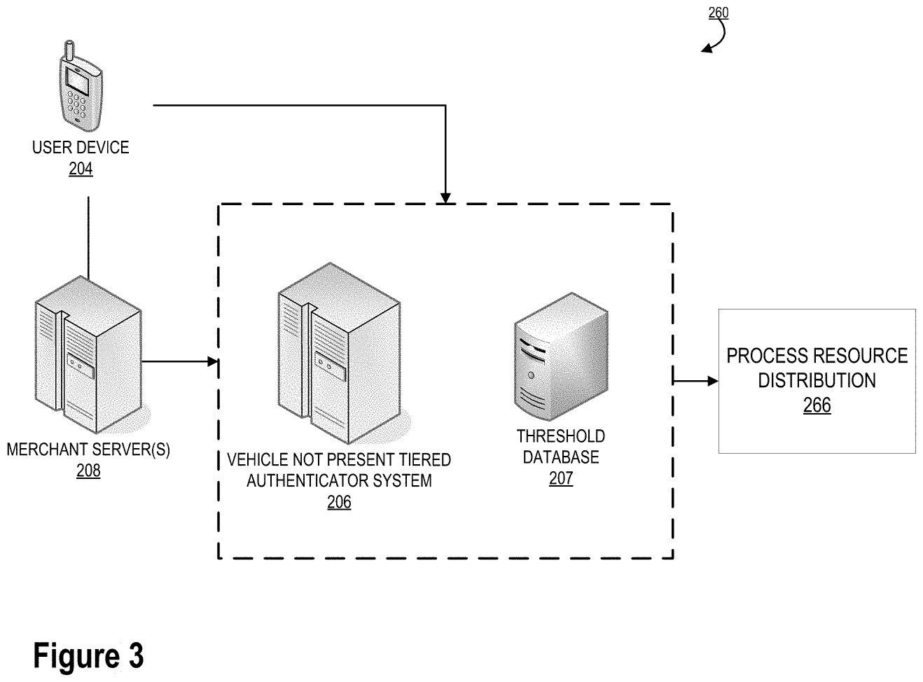

FIG. 3 provides a system interaction process for implementation the tiered authentication system for vehicle not present resource distribution communications 260, in accordance with one embodiment of the present invention. As illustrated, the process 260 may have a user device 204 in communication with a merchant server 208 performing a vehicle not present resource distribution for a user to purchase products or services from a merchant. In some embodiments, the merchant server 208 or the user device 204 may notify the vehicle not present tiered authenticator system 206 of the vehicle not present resource distribution being initiated. In other embodiments the vehicle not present tiered authenticator system 206 may interact with payment rails and user accounts to identify that a vehicle not present resource distribution is occurring.

Once the vehicle not present resource distribution is initiated, the vehicle not present tiered authenticator system 206 may extract the user matrix from the threshold database 207. The vehicle not present tiered authenticator system 206 may confirm if the vehicle not present resource distribution triggers the user matrix or not. If the vehicle not present tiered authenticator system 206 identifies that the vehicle not present resource distribution does not trigger the user's threshold matrix, the system allows the processing of the vehicle not present resource distribution, as illustrated in block 266. If the vehicle not present tiered authenticator system 206 identifies that the vehicle not present resource distribution triggers the user threshold matrix, the vehicle not present tiered authenticator system 206 may transmit an authentication notice to the user device 204 for user approval. Once the user approves the vehicle not present resource distribution from the user device 204 to the vehicle not present tiered authenticator system 206, the vehicle not present tiered authenticator system 206 may then allow for processing the resource distribution, as illustrated in block 266.

FIG. 4 provides a process flow illustrating setting up the user threshold matrix for the tiered authentication system 300, in accordance with one embodiment of the present invention. As illustrated in block 302, the process 300 is initiated by pushing and displaying a user threshold matrix options for the user. In this way, once the user has opted into the vehicle not present distribution communication tiered authenticator system, the system may push and display user threshold matrix options for the user to select.

The user threshold matrix options 302 may comprise a resource distribution type 304. The resource distribution type may comprise the type of product or service that the merchant may provide, this could be a category of product or service, such as electronics, home, or the like. The user may select one or more resource distribution types to be included into the threshold matrix for the user.

The user threshold matrix options 302 may comprise a resource distribution amount 306. The resource distribution amount may comprise the amount of the total resource distribution for the vehicle not present resource distribution. In this way, the resource distribution amount threshold may be a maximum amount the user may desire for the vehicle not present resource distribution to be processed without triggering an authentication notification. The user may select a maximum amount for resource distribution to be included into the threshold matrix for the user.

The user threshold matrix options 302 may comprise a merchant type 308. The merchant type may comprise the type of merchants associated with the vehicle not present resource distribution. These merchant types may include online only merchants, individual merchants, auction houses, or the like. The user may select the type of merchants to be included into the threshold matrix for the user.

The user threshold matrix options 302 may comprise a frequency 310. The frequency may be the amount of vehicle not present resource distributions that occur within a particular pre-determined set of time. The user may select a frequency standard to be included into the threshold matrix for the user.

The user threshold matrix options 302 may comprise the time 312. The time may be a time of day that the vehicle not present resource distribution may occur. In this way, the system may track a time of day that the user may require an authentication for a vehicle not present resource distribution. The user may select a time frame to be included into the threshold matrix for the user.

The user threshold matrix options 302 may comprise the location 314. The location may be the location of the merchant or the location of the user associated with the vehicle not present resource distribution. In this way, if the user or the merchant is a location that is pre-selected by the user, the system may require user authentication to complete the transaction. The user may select locations to be included into the threshold matrix for the user.

The user threshold matrix options 302 may comprise the terminal type 315. The terminal type may be the type of terminal associated with transaction, this may be the location that the credit card is inputted into at the merchant for completion of the transaction. In this way, if the type of terminal is pre-selected by the user, the system may require user authentication to complete the transaction. The user may select the type of terminals to be included into the threshold matrix for the user.

As illustrated in block 316, the process 300 continues by setting the threshold matrix for the user based on the user selections of the threshold matrix options. In this way, the user may be able to select one or more of the threshold matrix options for triggering an authentication notification. Once the user has selected the matrix options, the system may store them in a database for trigging of authentication notifications. As illustrated in block 318, the process 300 is finalized by deploying the threshold matrix for triggering of vehicle not present resource distribution communications tiered authentication requirements.

In some embodiments, the invention creates an instant notification process to notify a user when a transaction is occurring in a vehicle not present distribution. Furthermore, these notifications may be user controlled. In this way, the user may determine for what types of transactions, what merchant, a dollar amount, frequency, or the like as to when the notification is presented to the user. If the card vehicle not present distribution reaches the triggering threshold, a notification is provided to the user and must be accepted prior to allowing the transaction to be processed.

Embodiments of the invention are directed to a system, method, or computer program product for a vehicle not present distribution communications tiered authenticator. This invention creates an instant authentication notification process to notify a user when a resource distribution is occurring in a vehicle not present resource distribution event. A user threshold matrix is generated a pre-determined threshold for threshold datapoints associated with a vehicle not present resource distribution event. The invention identifies a vehicle not present resource distribution event and confirms if the even triggers the user threshold matrix. If so, an authentication communication is transmitted to the user for real-time vehicle not present resource distribution approval prior to allowance of rail processing.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for vehicle not present resource distribution communications tiered authentication, the system comprising:
a memory device with computer-readable program code stored thereon;
a communication device, wherein the communication device is configured to establish operative communication with a plurality of networked devices via a communication network;
a processing device operatively coupled to the memory device and the communication device, wherein the processing device is configured to execute the computer-readable program code to:
create linkage with a user device associated with a user, wherein the linkage is based on user authorization and links user resource distribution accounts for vehicle not present distribution communications identification;
pre-populate a user threshold matrix for vehicle not present resource distribution communications based on user selection of threshold matrix options;
identify a vehicle not present resource distribution communication with the user as a party to the communication;
compare details of the vehicle not present resource distribution communication not the user threshold matrix;
trigger, based on one or more thresholds being met from the threshold matrix options of the user, an authorization notification to a user device associated with the user; and
require a positive response from the user device to not block the vehicle not present resource distribution communication from processing.

2. The system of claim 1, wherein the user threshold matrix comprises threshold amounts for vehicle not present distribution communications related to the threshold matrix options comprising resource distribution types, merchant types, time of communications, resource distribution amount, frequency of communications, and location of the user and merchant during the vehicle not present distribution communications.

3. The system of claim 2, wherein the user threshold matrix comprises selection of one or more of the threshold matrix options.

4. The system of claim 1, wherein triggering the authorization notification to the user device associated with the user further comprises intercepting resource distribution processing at a payment rail for the vehicle not present resource distribution until confirmed authorization notification response.

5. The system of claim 1, wherein identifying the vehicle not present resource distribution communication with the user as a party to the communication further comprises monitor a payment rail for vehicle not present resource distributions associated with the user account.

6. The system of claim 1, wherein identifying the vehicle not present resource distribution communication with the user as a party to the communication further comprises receiving communication of the vehicle not present resource distribution communication from the user, a merchant, or a user account.

7. The system of claim 1, wherein requiring the positive response from the user device to not block the vehicle not present resource distribution communication from processing further comprises blocking the vehicle not present resource distribution communication upon no response being received from the user device, wherein blocking the vehicle not present resource distribution communication prevents a transaction from occurring.

8. A computer program product for vehicle not present resource distribution communications tiered authentication, the computer program product comprising at least one non-transitory computer-readable medium having computer-readable program code portions embodied therein, the computer-readable program code portions comprising:
an executable portion configured for creating linkage with a user device associated with a user, wherein the linkage is based on user authorization and links user resource distribution accounts for vehicle not present distribution communications identification;
an executable portion configured for pre-populating a user threshold matrix for vehicle not present resource distribution communications based on user selection of threshold matrix options;
an executable portion configured for identifying a vehicle not present resource distribution communication with the user as a party to the communication;
an executable portion configured for comparing details of the vehicle not present resource distribution communication not the user threshold matrix;
an executable portion configured for triggering, based on one or more thresholds being met from the threshold matrix options of the user, an authorization notification to a user device associated with the user; and
an executable portion configured for requiring a positive response from the user device to not block the vehicle not present resource distribution communication from processing.

9. The computer program product of claim 8, wherein the user threshold matrix comprises threshold amounts for vehicle not present distribution communications related to the threshold matrix options comprising resource distribution types, merchant types, time of communications, resource distribution amount, frequency of communications, and location of the user and merchant during the vehicle not present distribution communications.

10. The computer program product of claim 9, wherein the user threshold matrix comprises selection of one or more of the threshold matrix options.

11. The computer program product of claim 8, wherein triggering the authorization notification to the user device associated with the user further comprises intercepting resource distribution processing at a payment rail for the vehicle not present resource distribution until confirmed authorization notification response.

12. The computer program product of claim 8, wherein identifying the vehicle not present resource distribution communication with the user as a party to the communication further comprises monitor a payment rail for vehicle not present resource distributions associated with the user account.

13. The computer program product of claim 8, wherein identifying the vehicle not present resource distribution communication with the user as a party to the communication further comprises receiving communication of the vehicle not present resource distribution communication from the user, a merchant, or a user account.

14. The computer program product of claim 8, wherein requiring the positive response from the user device to not block the vehicle not present resource distribution communication from processing further comprises blocking the vehicle not present resource distribution communication upon no response being received from the user device, wherein blocking the vehicle not present resource distribution communication prevents a transaction from occurring.

15. A computer-implemented method for vehicle not present resource distribution communications tiered authentication, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
creating linkage with a user device associated with a user, wherein the linkage is based on user authorization and links user resource distribution accounts for vehicle not present distribution communications identification;
pre-populating a user threshold matrix for vehicle not present resource distribution communications based on user selection of threshold matrix options;
identifying a vehicle not present resource distribution communication with the user as a party to the communication;
comparing details of the vehicle not present resource distribution communication not the user threshold matrix;
triggering, based on one or more thresholds being met from the threshold matrix options of the user, an authorization notification to a user device associated with the user; and
requiring a positive response from the user device to not block the vehicle not present resource distribution communication from processing.

16. The computer-implemented method of claim 15, wherein the user threshold matrix comprises threshold amounts for vehicle not present distribution communications related to the threshold matrix options comprising resource distribution types, merchant types, time of communications, resource distribution amount, frequency of communications, and location of the user and merchant during the vehicle not present distribution communications.

17. The computer-implemented method of claim 15, wherein triggering the authorization notification to the user device associated with the user further comprises intercepting resource distribution processing at a payment rail for the vehicle not present resource distribution until confirmed authorization notification response.

18. The computer-implemented method of claim 15, wherein identifying the vehicle not present resource distribution communication with the user as a party to the communication further comprises monitor a payment rail for vehicle not present resource distributions associated with the user account.

19. The computer-implemented method of claim 15, wherein identifying the vehicle not present resource distribution communication with the user as a party to the communication further comprises receiving communication of the vehicle not present resource distribution communication from the user, a merchant, or a user account.

20. The computer-implemented method of claim 15, wherein requiring the positive response from the user device to not block the vehicle not present resource distribution communication from processing further comprises blocking the vehicle not present resource distribution communication upon no response being received from the user device, wherein blocking the vehicle not present resource distribution communication prevents a transaction from occurring.
